(19) United States
(12) Patent Application Publication
(10) Pub. No.: US 2007/0181607 A1
(43) Pub. Date: Aug. 9, 2007

(54) Caulking gun

(76) Inventors: Rafael Adolfo Calvo, Altadena, CA (US); Janet Ellis Calvo, Altadena, CA (US)

Correspondence Address: RAFAEL A. CALVO, 455 W. ALTADENA DRIVE, ALTADENA, CA, 91001, US

(21) Appl. No.: 11/698,735

(22) Filed: Jan. 26, 2007

Related U.S. Application Data
(60) Provisional application No. 60/763,469, filed on Jan. 27, 2006.

(51) Int. Cl. B67D 5/42; B67D 5/00

(52) U.S. Cl. 222/391; 222/80

(57) ABSTRACT

A caulking gun includes a cartridge holder, a stock, a plunger, actuator plates, an actuator spring, an adjustable handle, a trigger, a nozzle cutter, a cartridge poker and a retractable arm clip. A handle, able to slide along a lower rail of a cartridge holder, is engaged and disengaged using a trigger. Said handle permits a user to adjust the balance point of the gun at will. To disengage the handle, a trigger is lifted, releasing a forked tab at the rear of the handle that engages the lower rail. Squeezing the trigger reengages the forked tab. The actuator plates are aligned such that a cartridge's internal pressure is relieved each time the trigger is released. A nozzle cutter provides a clean cut, and allows for nozzle tips to be easily discarded. A retractable arm clip is used as a secondary contact point with a user's arm.

### FIELD OF THE INVENTION

The invention described below relates to hand tools and, more particularly, to manually actuated caulking guns.

### BACKGROUND OF THE INVENTION

Caulking guns have been developed to provide a convenient way to dispense caulking or silicone compounds from cartridges. The cartridges themselves are generally made with a built-in plastic nozzle and provide a sliding plug on the opposite end of the nozzle. Caulking guns generally include a cartridge holder, a plunger with a shaft for pushing the compound in the cartridge, a handle and a trigger mechanism for advancing the plunger. Once the tip of a nozzle is cut, the seal of a cartridge broken using a poker and the cartridge has been placed in the gun, a user squeezes the trigger, advancing the plunger. The plunger in turn pushes the plug and the cartridge extrudes compound. The previous art generally includes a handle and a plunger advancing mechanism towards the back end of the gun. These guns commonly use two coil springs to achieve the tensions necessary on the plunger's parts. Some more sophisticated guns have “no drip” features that release the pressure on the plungers so that compound does not leak from the nozzles when not in use. Current automatic pressure release mechanisms use additional springs and parts to relieve pressure on the cartridge. These mechanisms relieve a plunger's pressure each time a trigger is released. Other guns require a user to depress a tab to release pressure on the cartridges. Some caulking guns include built-in nozzle (snout) cutters. U.S. Pat. No. 6,045,005 describes a circular opening in the side of a handle with a blade on a trigger for cutting the tip of a nozzle. Although a need for simple construction has been noted in the prior art, multiple coil springs have remained common to most caulking guns, some using as many as three springs, cables, ratchets and tabs which a user must activate to operate.

The construction and operation of common caulking guns necessitate a user to hold the gun with both hands for accurate delivery of compound. Usually one hand cradles a cartridge holder and cartridge; the hand's position supports the majority of the gun's weight. The other hand grips a handle and squeezes a trigger. Although this method of operation is adequate for many uses, some applications do not readily allow a user to hold a gun with both hands. In such cases, a user must support the weight of the entire gun with one hand putting added stress on the user's wrist and making precise delivery of compound more difficult. Some situations call for a user to use one hand for bracing his/her own body and only use a gun with the other hand, for example while standing on a ladder. Other situations call for a user to hold an object with one hand and apply compound with a gun in the other hand. In these cases, the user must draw back the hand holding the gun to align a nozzle's tip with the object being held. Operating a common caulking gun in a drawn back position is awkward, potentially imprecise and may quickly fatigue a user's wrist.

Although the usual design of caulking guns includes a handle and trigger at the rear, two patents show variations to this arrangement. U.S. Pat. No. 6,640,998 describes a device wherein a cartridge holder slides back against a non-moving plunger. Although this action claims to improve the balance of their invention during use, the entire weight of a full cartridge still hangs in front of a user's hand when a new cartridge is placed in the device. Furthermore, this design has the drawback that as a trigger is squeezed, a nozzle's tip pulls away from the point of contact. This motion requires that a user constantly adjust the gun forward during use. U.S. Pat. No. 4,957,223 describes a handle that is placed towards the front of a caulking gun and uses a complex combination of springs and cables to cause it to function. This design may allow for a better balance at the beginning of use if only one hand holds such a gun, but the device does not allow for the option to operate it by the method of cradling the gun with one hand and gripping the handle with the other hand.

### BRIEF SUMMARY OF THE INVENTION

It is, accordingly, the object of the present invention to provide a caulking gun whose balance point is adjustable.

Another object of the present invention is to provide the ability to adjust the balance point even while a cartridge remains in a cartridge holder.

Another object of the present invention is to be usable and balanced with either a two-handed grip or single-handed grip.

Another object of the present invention is to provide a sliding handle for adjusting and setting the balance point of a gun.

Another object of the present invention is to provide a simple mechanism for the disengagement and reengagement of a handle from an upper body of the gun using a trigger.

Still another object of the present invention is to reduce the number of springs in an advancing mechanism by eliminating the need for multiple springs, and instead use one spring.

Another object of the present invention is to provide a simple automatic means to relieve pressure on a cartridge to prevent oozing after a trigger is squeezed and released without the need for additional springs.

Yet another object of the present invention is to move the location of a nozzle cutter away from the inside of a handle where plastic nozzle tips and caulking compound may lodge; and to move it to the front of a gun where it is more visible, in alignment with a handle and where cut nozzle tips will not be trapped.

Another object of the present invention is to provide an arm support clip that may be employed or left in a retracted position.

Still another object of the present invention is to provide a design that is easy to manufacture and assemble.

The design of this invention has a cartridge holder portion which includes a disk with an opening for a cartridge nozzle, two parallel cartridge rails that extend rearward, a hollow stock portion connected to said rails wherein is found an actuator spring, actuating plates—one plunger advancing plate and one plunger restraining plate—and through which a plunger shaft passes.

A handle and trigger are positioned below a cartridge holder and stock, and can slide along a lower cartridge rail. A means must connect a trigger and a plunger advancing plate such that it causes said plate to move forward when said trigger is squeezed, yet allows adjustment of the handle's position should a user prefer a different balance point for the gun.

Two separate functions are required to allow a handle to slide: First, a handle repositioning means must be able to disengage a handle from a gun's lower cartridge rail, allow said handle to move to a new position, and then reengage said handle. Second, a plunger advancing means must be able to disengage a trigger from a plunger advancing plate, allow a handle to be moved to a new position, and then reengage said trigger to said plate.

Here described are four embodiments of mechanisms that connect a handle to the rest of a gun and a trigger to a plunger advancing plate.

In a first embodiment, these two actions must be performed separately; each action designed to operate independently using fasteners that engage a handle into indentations in a lower cartridge rail and fasteners that engage a trigger into indentations in a connecting bar (otherwise referred to as a trigger bar) that extends back to a plunger advancing plate. Two examples of fastener types include locking tabs that slide up or down, or thread screws. A user is required to release a fastener that locks a handle to a gun, release a fastener that connects a trigger to a trigger bar, move the handle's position, then re-lock each fastener.

In a second embodiment, two separate sprung tabs engage a handle to indentations in a lower rail and a trigger to indentations in a trigger bar. These tabs are placed in alignment such that as a user pushes a button at the rear of said handle, a shaft, connected to said button and positioned inside said handle, engages said tabs. Said shaft moves forward, collapses said tabs simultaneously, permitting said handle to be positioned at a different point along the gun; releasing said button resets said tabs against said indentations. This arrangement requires that both tabs align with their respective indentations simultaneously for a handle and trigger to be reengaged for use.

With a third embodiment, a spool, positioned transversely to a handle, is connected to a trigger. A thin cable wraps around said spool, extends back, and is connected to a tab in a plunger advancing plate. When said trigger is squeezed, rather than spin, said spool locks and is pushed forward. To release said handle for repositioning along the gun, a forked tab attached to said handle slides up and down, releasing said handle from a lower cartridge rail. As said handle slides, said spool automatically picks up or releases slack on said cable as needed.

A fourth and preferred embodiment provides a sliding vertical forked tab at the rear of a handle, said tab engaging indentations in a lower cartridge rail; and a trigger including a toothed extension, a trigger bar having indentations, said extension and trigger bar indentations engaging only when said trigger is squeezed. A spring is positioned inside the trigger: one end of said spring biases said trigger away from a handle, the other end of said spring is attached to said tab. With this arrangement, a handle can be released, moved and then relocked in one easy maneuver using only a trigger.

Attached to the lower forward portion of a lower cartridge rail, a brace includes an opening to receive and support the front edge of a trigger bar—the front edge of said bar being sharpened or including a small blade. Another opening in said brace allows nozzles of common cartridges to be inserted therein. Said sharpened edge and brace thus form a guillotine type nozzle cutter.

A plunger restraining plate is bent backwards and straddles the upwardly sloping rear portion of a trigger bar. As said bar begins moving forward when a trigger is squeezed, it engages said plate, lifting it slightly releasing a plunger shaft. As said trigger is released, said plate is delayed in restraining said shaft, thus permitting said shaft to slide rearwards slightly, relieving pressure on a cartridge. This action occurs automatically each time a trigger is released after being squeezed.

An arm clip, pivotally attached to a stock, may be used to give a second point of contact with a user's arm for greater support, accuracy and endurance.

Although multiple springs may be used to produce the actions necessary for the actuator plates to function, a single actuator spring design simplifies the construction of the gun. A single spring design may be used with a gun that does not have a sliding handle. In the preferred embodiment, a caulking gun includes a sliding handle, is manufactured as simply as possible and allows for both a handle and trigger to release for adjustment with one simple maneuver.

### BRIEF DESCRIPTION OF THE DRAWINGS

FIG. 1 is a side elevation, general view of a caulking gun with a sliding handle, shown set forward and shadowed in the rearward position, a pivotally mounted arm clip set upward and shadowed in the downward position, a pivotally mounted cartridge poker set retracted and shadowed in the extended position, and a nozzle cutter located near the front of the invention, away from the inside of said handle.

FIG. 2 is a side, sectional, perspective, inside view of a stock with stock cover removed, including actuator plates, an actuator leaf spring, trigger bar and plunger shaft.

FIG. 3 is a side, sectional, perspective, inside view of a stock with stock cover removed, including actuator plates, an actuator coil spring, trigger bar and plunger shaft.

FIG. 4 is a side, sectional, perspective, inside exposed view of a handle, its side wall removed for viewing, including a handle monorail, a trigger, trigger extension, trigger spring, forked tab, tab bracket and a nozzle cutter.

FIG. 5 is a side, sectional, perspective close up view of a nozzle cutter with a portion of the brace removed for viewing, exposing the trigger bar sharpened edge/blade.

FIG. 6 is a side elevation, general view of a caulking gun with a stock with integrated non-sliding handle, a nozzle cutter still set away from said handle.

FIG. 7 is a side, sectional, perspective view of a caulking gun with a non-sliding handle, the side wall of said handle removed for viewing, exposing the hollow of a stock containing actuator plates, actuator leaf spring, plunger shaft and nozzle cutter.

FIG. 8 is a side, sectional, perspective view of a caulking gun with a stock with integrated non-sliding handle, the side and rear walls of said handle removed for viewing, exposing a nozzle cutter, a trigger, a trigger spring, trigger extension, trigger bar, actuating plates, and actuator coil spring.

### DETAILED DESCRIPTION OF THE ILLUSTRATED EMBODIMENTS

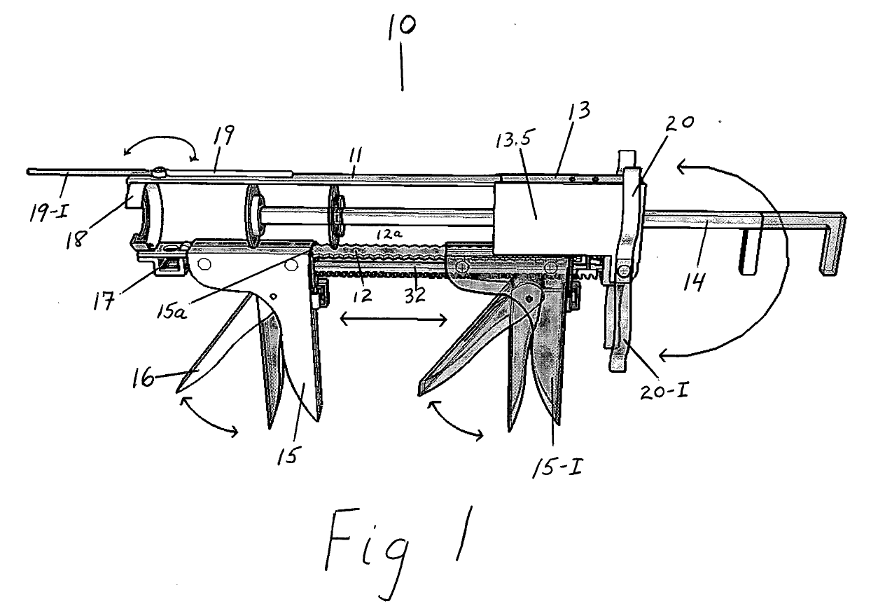

Referring to the drawings, in particular to FIG. 1, there is shown generally at (10) a caulking gun incorporating the features of the invention. The upper body of caulking gun (10) includes a cartridge holder defined by a disk (18) and cartridge rails (11) and (12). A stock (13) with stock cover plate (13.5) overlaps and attaches to upper cartridge rail (11). Plunger (14) passes through stock (13) and upper cartridge rail (11). Cartridge poker (19), pivotally mounted on upper cartridge rail (11), may be rotated 180 degrees forward, shown shadowed in forward position as poker (19-I). Arm clip (20), pivotally attached to stock (13), may be turned downwards 180 degrees, shown shadowed in downward position as clip (20-I).

A sliding handle (15) with trigger (16) is channeled (15a), permitting lower cartridge rail (12) to pass there through. Lower cartridge rail (12) includes indentations (12a) along its long axis. Handle (15) may be set anywhere along lower cartridge rail (12) at any given indentation (12a). Handle (15) also shown shadowed in the rearward position as handle (15-I). Nozzle cutter (17), attached to rail (12), supports the front edge of trigger bar (32).

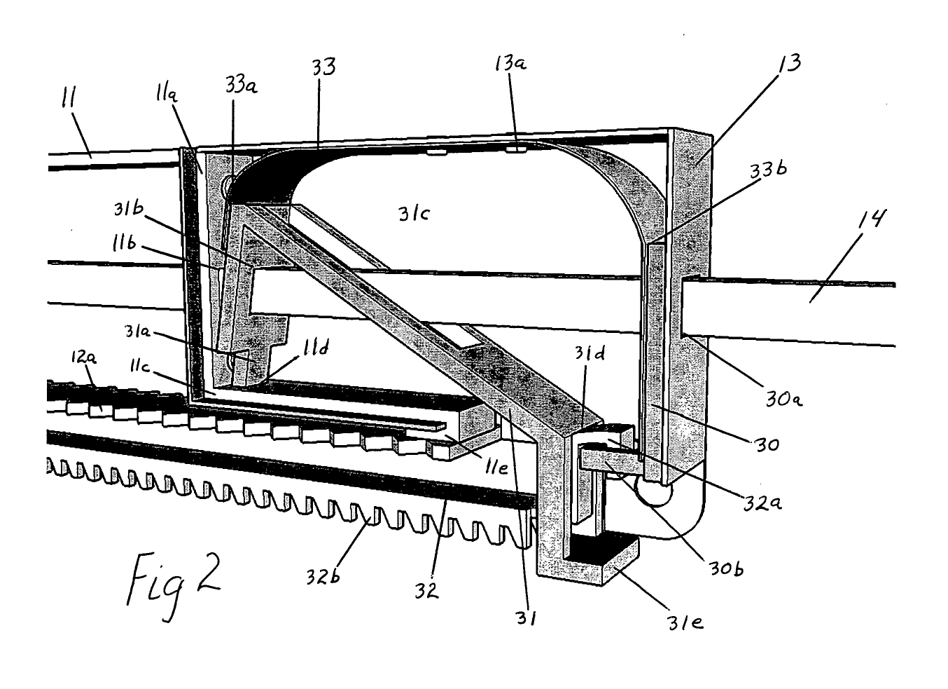

Referring now to FIG. 2, there is shown a stock cover plate (13.5) having been removed for viewing, the upper cartridge rail (11) bends downward at point (11a); has opening (11b) through which plunger shaft (14) passes, bends rearward again at point (11c) and contacts lower cartridge rail (12) at point (11e). Plunger restraining plate (31) is anchored with foot (31a) to upper cartridge rail (11) at point (11d); extends upwards; has opening (31b) through which plunger shaft (14) passes; extends rearward and downward, plunger shaft (14) again passing through unrestricted at point (31c); bends downward and is forked at point (31d) leaving an angled plane to contact trigger bar (32) at a point (32a) only when trigger bar (32) moves forward; straddles trigger bar (32) bending rearward again and terminating with tab (31e). Plunger advancing plate (30) extends downward, has plunger shaft (14) pass through at point (30a), extends further downward terminating with tab extension (30b). Actuator spring (33) is attached to the upper inside plane of stock (13) at point (13a); contacts plate (31) at point (33a) exerting rearward pressure on plate (31); and contacts plate (30) at point (33b) exerting rearward pressure on plate (30). As trigger bar (32) moves forward when a trigger is squeezed, sloped segment (32a) forces plate (31) upwards at point (31d). Said motion releases shaft (14) at point (31b). As trigger bar (32) slides rearward when the trigger is released, plate (31) remains slightly elevated and is delayed in contacting shaft (14).

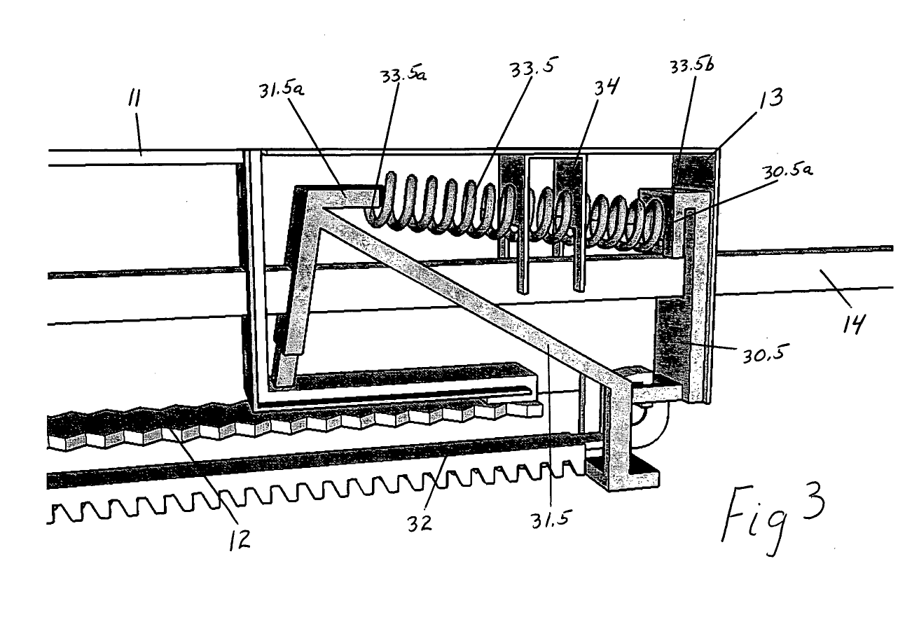

Referring now to FIG. 3, there is shown a second embodiment of an actuator coil spring (33.5) attached to stock (13) with bracket (34). Said spring attached to restraining plate tab (31.5a) at point (33.5a) and attached to plate (30.5) at point (33.5b); plate (30.5) using plate tab (30.5a) to keep spring (33.5) in place.

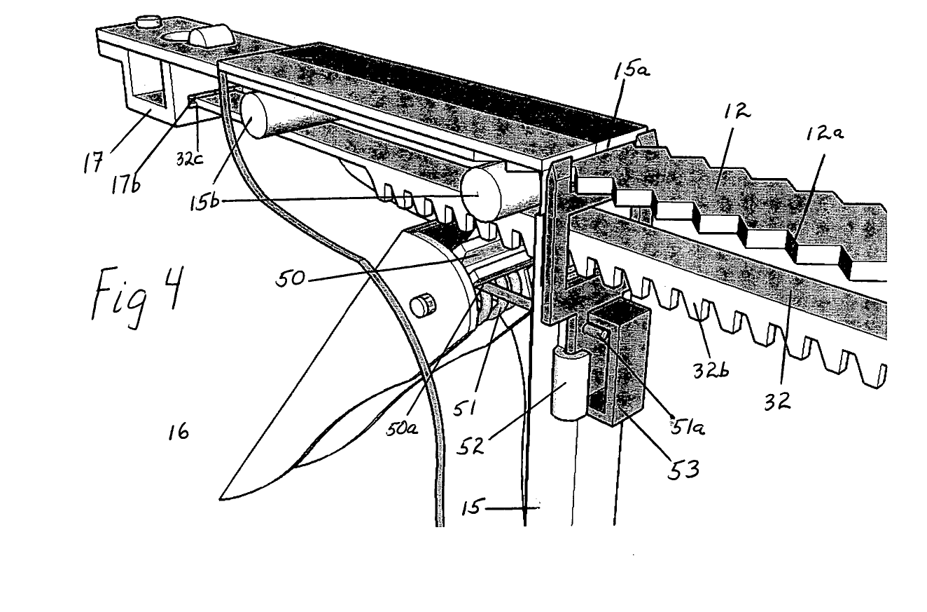

Referring now to FIG. 4, there is shown a cross sectional view of a handle (15) which includes channel (15a) through which rail (12) passes there through, the monorail alignment secured with fasteners (15b). Forked tab (53) slides along bracket (52) and DETAILED DESCRIPTION OF THE ILLUSTRATED EMBODIMENTS—Page 2 engages lower rail (12) at any of a series of teeth (12a). Spring (51), positioned inside trigger (16) engages tab (53) with spring end (51a). Toothed extension (50), positioned inside trigger (16) and straddling spring (51), contacts spring (51) at point (50a). The top of extension (50) engages trigger bar teeth (32a) only when trigger (16) is squeezed, as both trigger (16) and extension (50) rotate more vertically. When trigger (16) is lifted away from handle (15), extension (50) pushes spring end (51a) downward; spring end (51a) pushes tab (53) downward, disengaging tab (53) from rail teeth (12a). Trigger bar (32) extends forward, terminating at opening (17b) of brace (17). A sharpened edge with blade (32c) rests on the edge of brace (17).

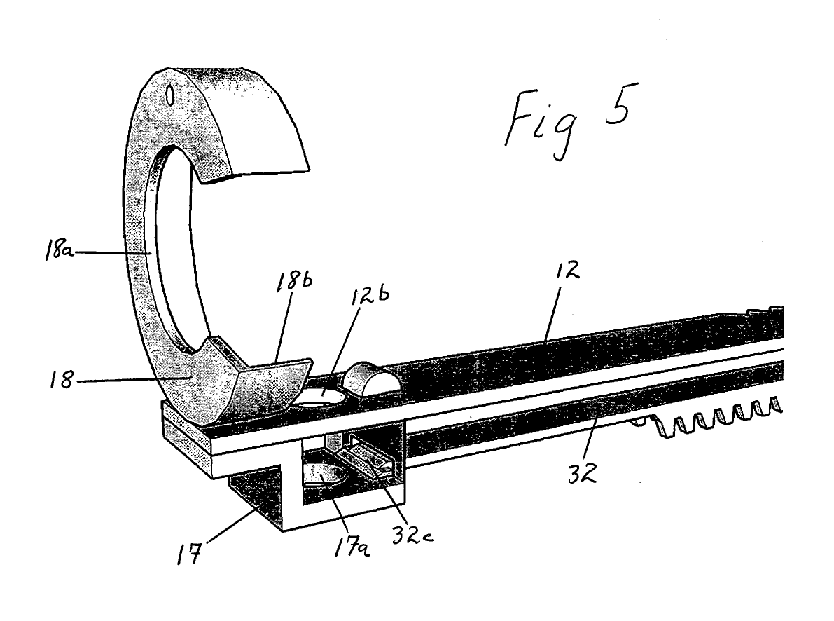

Referring now to FIG. 5, there is shown a side, sectional view of nozzle cutter (17), a portion of brace (17) removed, exposing the front edge of trigger bar (32). Brace hole (17a) aligns with lower rail hole (12b) permitting a nozzle to be inserted and then sliced by edge (32c). Front disk (18) includes a flange (18b) for securing a body of a cartridge when a nozzle is inserted into opening (18a).

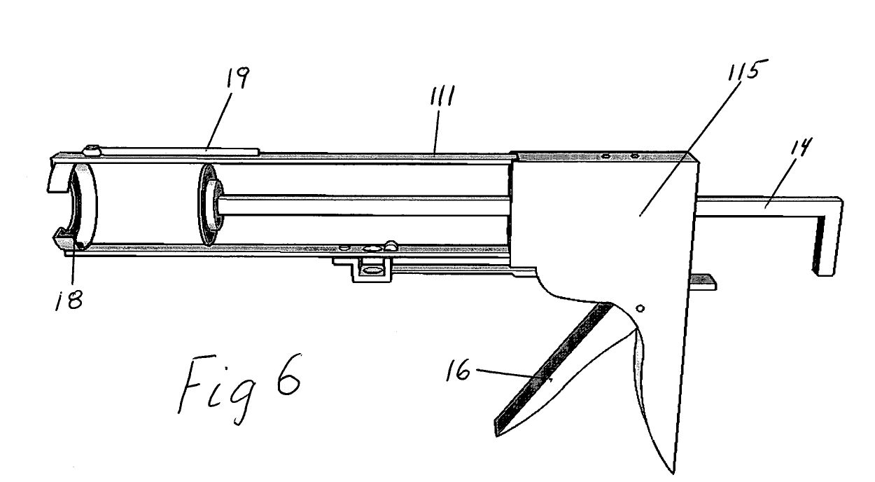

Referring now to FIG. 6, there is shown generally at (110) a caulking gun incorporating the actuating features of the invention with a non-sliding handle (115). Said gun includes a cartridge holder comprising disk (18); cartridge rail (111), said rail constructed to form both upper and lower portions of the cartridge rail as a continuous single piece; a plunger (14) a trigger (16); a nozzle cutter (17); and a cartridge poker (19).

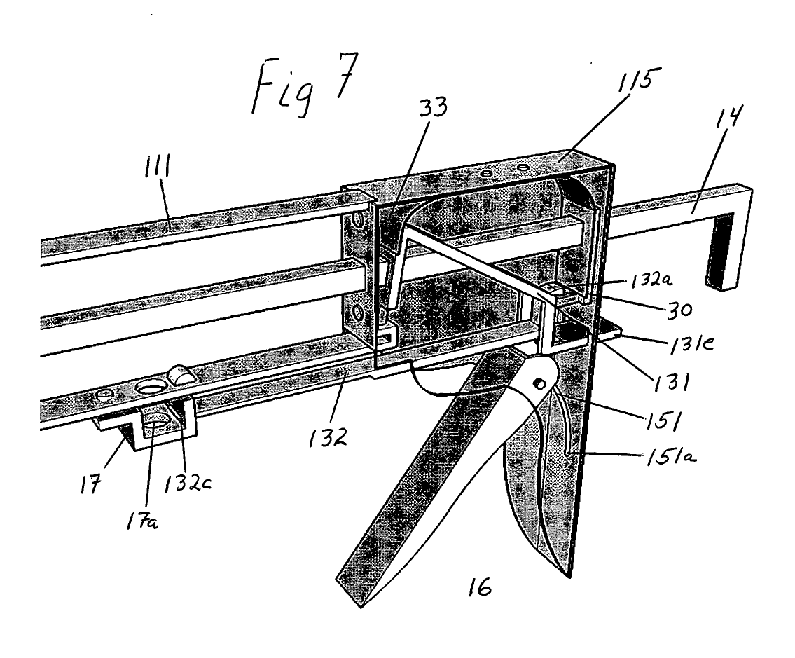

Referring now to FIG. 7, there is shown a side, sectional, perspective view wherein cartridge rail (111) is formed from one continuous piece—forming both the upper and lower segments of the cartridge holder, the hollow of stock/handle (115) includes actuator spring (33), plunger advancing plate (30), a plunger restraining plate with a terminating rear tab (131e) extending past the rear of stock/handle (115), and a rearward end (151a) of a trigger spring (151) bends downward contacting the inside of stock/handle (115). Trigger bar (132) has only 2 teeth (blocked by plate (131)) and enters brace (17). Brace (17) includes an opening (17a), and bar (132) includes sharpened edge/blade (132c), both forming a guillotine type cutter.

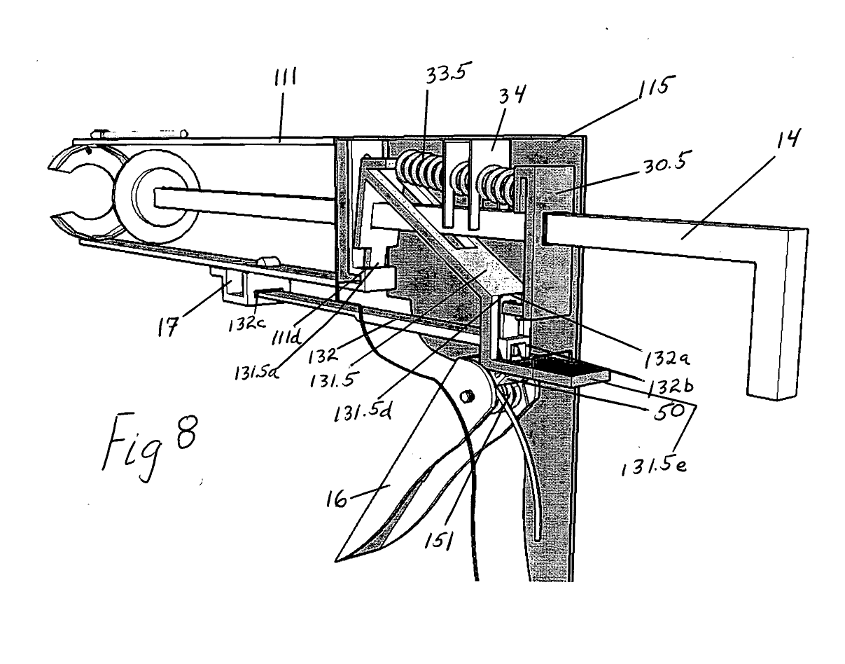

Referring now to FIG. 8, there is shown a side, sectional, perspective view of stock/handle (115), one side removed for viewing, a second embodiment of actuator coil spring (33.5) attached to stock/handle (115) with bracket (34). Plunger restraining plate (131.5) includes a tab (131a) that extends past the rear of stock/handle (115). Cartridge rail (111) is shown including hole (111d) into which foot (131.5a) of plate (131.5) is secured. Trigger bar (132) includes an upwardly sloped segment (132a) wherein said segment contacts and lifts plate (131.5) at point (131.5d), thus delaying plate (131.5) from restraining shaft (14) when trigger (16) is released after being squeezed.

We claim:

1. A caulking gun comprising:
a cartridge holder;
a stock;
a plunger;
actuator plates;
at least one actuator spring;
a repositionable handle;
a trigger;
a handle repositioning means;
a plunger advancing means;
a nozzle cutter;
a cartridge poker;
and an arm clip.

2. A caulking gun according to claim 1 wherein a cartridge holder comprises:
a disk with an opening sufficient for receiving the front end of common cartridges;
and two cartridge rails which extend back from the top and bottom of the disk, further defining the cartridge holder portion, the upper rail bending downward contacting the lower rail.

3. A caulking gun according to claim 2 wherein a lower cartridge rail includes a series of indentations such as teeth, notches or holes cut along its long axis.

4. A caulking gun according to claim 2 wherein an upper cartridge rail includes a hole, midway between the upper and lower cartridge rails, permitting a plunger shaft to slide smoothly there through.

5. A caulking gun according to claim 1 wherein a stock attaches to an upper cartridge rail and includes a hollow central space.

6. A caulking gun according to claim 1 wherein at least one actuator spring, two examples of said spring include coil or leaf, attaches from the spring's general midsection to the inside of the hollow of a stock.

7. A caulking gun according to claim 1 wherein actuator plates are positioned inside the hollow stock; said plates further being defined as comprising:
a first plate—a plunger advancing plate—which advances a plunger when the trigger is squeezed;
and a second plate—a plunger restraining plate—which holds a plunger in place when a trigger is not squeezed.

8. A caulking gun according to claim 1 wherein a plunger's shaft passes through a stock, plunger advancing plate, plunger restraining plate and an upper cartridge rail.

9. A caulking gun according to claim 7 wherein:
one end portion of an actuator spring is tensioned onto a plunger restraining plate, exerting rearward pressure on said plate—the forward end of said plate anchored to the inside of a stock—thus engaging a plunger's shaft and restricting free movement;
and another end portion of said spring is exerting rearward pressure on a plunger advancing plate.

10. A caulking gun according to claim 1 wherein a handle includes a channeled plane at its top, coplanar with a lower cartridge rail, through which said rail passes, allowing said handle to travel forwards and rearwards along said rail like a monorail.

11. A caulking gun according to claim 1 wherein a handle repositioning means engages and disengages a handle from a lower cartridge rail's indentations.

12. A caulking gun according to claim 11 wherein a handle repositioning means may include a forked tab and bracket; said forked tab able to slide up or down, able to lock a handle at any point along a lower cartridge rail.

13. A caulking gun according to claim 11 wherein a handle repositioning means may include threaded screws or sprung tabs.

14. A caulking gun according to claim 1 wherein a plunger advancing means consists of a means that engages a trigger to a plunger advancing plate.

15. A caulking gun according to claim 14 wherein a plunger advancing means includes a spool of wire in a trigger, said wire attached to a plunger advancing plate, said spool locking each time a trigger is squeezed.

16. A caulking gun according to claim 14 wherein a plunger advancing means includes:
a bar (trigger bar) having a series of indentations such as teeth, notches or holes and is connected to a plunger advancing plate;
a toothed extension at the top end of a trigger;
a trigger spring, positioned inside said trigger, biasing the trigger away from a handle when said trigger is not squeezed.

17. A caulking gun according to claim 16 wherein a trigger toothed extension touches and engages a trigger bar's indentations only when a trigger rotates vertically as it is squeezed.

18. A caulking gun according to claim 1 wherein a nozzle cutter means includes:
a brace attached to the lower edge of a lower cartridge rail;
an opening supporting the front edge of a trigger bar;
a sharpened front edge of a trigger bar or a bar having a small blade attached thereon;
an opening able to receive a nozzle of a cartridge;
said brace and trigger bar thus forming a guillotine type cutter each time said trigger bar moves forward.

19. A caulking gun according to claim 1 wherein a cartridge poker is pivotally mounted to the top of an upper cartridge rail, permitting rotation of said poker 180 degrees forward as needed to break the seal of a cartridge.

20. A caulking gun according to claim 1 wherein a retractable arm clip is pivotally attached to a stock; said clip, when turned downward, rests snugly around a user's arm, providing a secondary contact point with a user.

21. A caulking gun according to claim 16 wherein a trigger bar, being slightly upwardly sloped as it extends backwards near a plunger advancing plate, and wherein a plunger restraining plate includes an extension that nearly touches said sloping edge, said bar engages and lifts momentarily said extension, releasing a plunger shaft; as a trigger is released, said restraining plate is delayed in restraining said plunger shaft until said bar completely returns to its at rest position; said delay permitting said plunger to move slightly backwards away from a cartridge, relieving pressure inside said cartridge.

22. A method for disengaging and reengaging a sliding handle of a caulking gun using a trigger comprising the steps of:
lifting a trigger upwards away from a handle, said motion pivoting a trigger extension downwards;
said extension rotation pushing a rearward facing trigger spring end downwards;
said rearward end of spring, attached to a forked tab at the rear of said handle, in turn forcing said tab downwards and disengaging said handle from a lower cartridge rail's indentations;
and once said handle has been repositioned, squeezing said trigger produces greater tension on said spring, thus pushing said tab upwards into different indentations of said rail, reengaging said handle.

23. A caulking gun comprising:
a cartridge holder;
a stock;
a fixed handle, said handle being formed as a unitary extension of a hollow stock;
a trigger;
a plunger;
actuator plates;
at least one actuator spring;
a plunger advancing means;
a nozzle cutter;
and a cartridge poker;
thus providing a conventional gun design with a fixed handle towards the rear of the gun.

24. A caulking gun according to claim 23 wherein at least one actuator spring, two examples of said spring include coil or leaf, attaches from the spring's general midsection to the inside of the hollow of a stock.
